(19) United States
(12) Patent Application Publication
(10) Pub. No.: US 2023/0167860 A1
(43) Pub. Date: Jun. 1, 2023

(54) COMPACT, HIGH-CAPACITY, LONG-LIFE CLUTCHES

(71) Applicant: PT Tech, LLC, Wadsworth, OH (US)

(72) Inventors: Brian J. Peet, Akron, OH (US); Andrew F. Aylward, Rocky River, OH (US)

(21) Appl. No.: 17/917,763

(22) PCT Filed: Apr. 14, 2020
(86) PCT No.: PCT/US2020/028097

§ 371 Date: Oct. 7, 2022

(51) Int. Cl. F16D 25/0638; F16C 19/36; F16D 13/58

(52) U.S. Cl. CPC F16D 25/0638; F16C 19/364; F16D 13/58; F16C 2361/43

(57) ABSTRACT

A compact, long-life clutch assembly employs a bearing and shaft system having a preloaded tapered roller bearing accommodating both high radial loads and axial loads while accommodating system misalignment resulting from such loads, deflections, and structural characteristics of input/output devices. A bell housing and end cover integrated into a single casting reduces costs, while the utilization of wave springs accommodate reduction in size and expense in manufacture and servicing.

### TECHNICAL FIELD

The invention herein resides in the art of power transmission devices and, more particularly, to compact clutches. Specifically, the invention relates to fluid-actuated clutches adaptable for use in both transverse and direct applications accommodating both high radial and axial loads and employing a readily serviceable disc pack.

### BACKGROUND OF THE INVENTION

Present-day power sources and loads require the implementation of clutches that must be limited in physical size, while accommodating high axial loads from disc pack engagement alone, or with high radial loads from belt drives or the like. Moreover, present-day clutches must accommodate ease of serviceability and repair due to disc stack wear life. In like manner, it is most desirable that the disc pack wear life not be compromised by the reduction in size and complex nature of the clutch housing.

Cost is an ever-present consideration in machine design and, in that regard, it is most desirable that clutches and the like demonstrate cost savings over those of the prior art. Time and expense incident to the use of multiple castings, complex seals, and machined features often frustrate the desire for system economy without sacrificing performance.

Indeed, there is a need in the art for compact, high-capacity, long-life, cost-effective clutches that accommodate system economy, ease of serviceability, repair, and refurbishment.

### SUMMARY OF THE INVENTION

In light of the foregoing, it is a first aspect of the invention to provide a compact, high-capacity, long-life clutch employing a splined disc pack interface to accommodate a tight axial package.

Another aspect of the invention is to provide a compact, high-capacity, long-life clutch to replace angular contact ball bearings of the past with a thrust bearing, such as a tapered roller bearing, for axial engagement.

A further aspect of the invention is to provide a compact, high-capacity, long-life clutch employing a bearing and shaft system comprised of a pair of spaced-apart, tapered roller bearings in a preloaded condition to accommodate both higher radial and axial loads, or axial loads with no radial load present, such as in direct-drive applications.

Yet another aspect of the invention is to provide a compact, high-capacity, long-life clutch that accommodates system misalignment resulting from loads, deflections, and structural peculiarities of the system to which the clutch is mounted.

Still a further aspect of the invention is the provision of a compact, high-capacity, long-life clutch that accommodates both transverse and direct applications using the same bearing arrangement.

An additional aspect of the invention is the provision of a compact, high-capacity, long-life clutch that prevents rotation of bearing races relative to the shaft.

Still a further aspect of the invention is the provision of a compact, high-capacity, long-life clutch that employs a nested wave spring to preload an inner bearing to prevent rotation and allow for ease of installation and rebuild.

Yet another aspect of the invention is the provision of a compact, high-capacity, long-life clutch that employs an oil level sensor to disengage the clutch when the oil level drops below a threshold.

Another aspect of the invention is to provide a compact, cost-effective clutch for low-power applications employing a unitary integrated casting without a need for auxiliary housings.

An additional aspect of the invention is to provide a compact, cost-effective clutch for low-power applications in which all hydraulic chambers are built within the housing.

A further aspect of the invention is to provide a compact, cost-effective clutch for low-power applications with simplified sealing mechanisms.

Yet another aspect of the invention is to provide a compact, cost-effective clutch for low-power applications employing a custom crest-to-crest wave spring in the disc pack to reduce the time and expense incident to machining for use of other force-inducing members.

The foregoing and other aspects of the invention are attained by a compact, long-life clutch, comprising a shaft; an endplate and a pressure plate operatively mounted to an end of said shaft; at least one friction disc interposed between said endplate and pressure plate; a drive ring adapted for driven engagement by a power source and receiving said at least one friction plate; a bell housing adapted for mounting to a housing of said power source and enclosing said endplate, pressure plate, and friction disc; and wherein said shaft is rotatably mounted within an end cover by first and second tapered roller bearings.

Additional aspects of the invention that will become apparent as the detailed description proceeds are achieved by a compact, long-life clutch, comprising a shaft rotatably mounted within an end cover by first and second tapered roller bearings; an endplate and a pressure plate operatively mounted to an end of said shaft; at least one friction disc interposed between said endplate and pressure plate; a drive ring adapted for driven engagement by a power source and receiving said at least one friction disc; a bell housing adapted for mounting to a housing of said power source and enclosing said endplate, pressure plate and friction disc; and a hydraulic piston engaging said pressure plate and a thrust bearing for said pressure plate interposed between said pressure plate and hydraulic piston.

### BRIEF DESCRIPTION OF THE DRAWING

For a complete understanding of the various aspects of the invention, reference should be made to the following detailed description and accompanying drawings wherein:

FIG. 1 is a cross-sectional view of a compact, high-capacity, long-life clutch made in accordance with the invention; and

FIG. 2 is a cross-sectional view of a second embodiment of the invention, showing a compact, cost-effective clutch for low-power applications, similar to the embodiment of FIG. 1.

### DETAILED DESCRIPTION OF PREFERRED EMBODIMENT

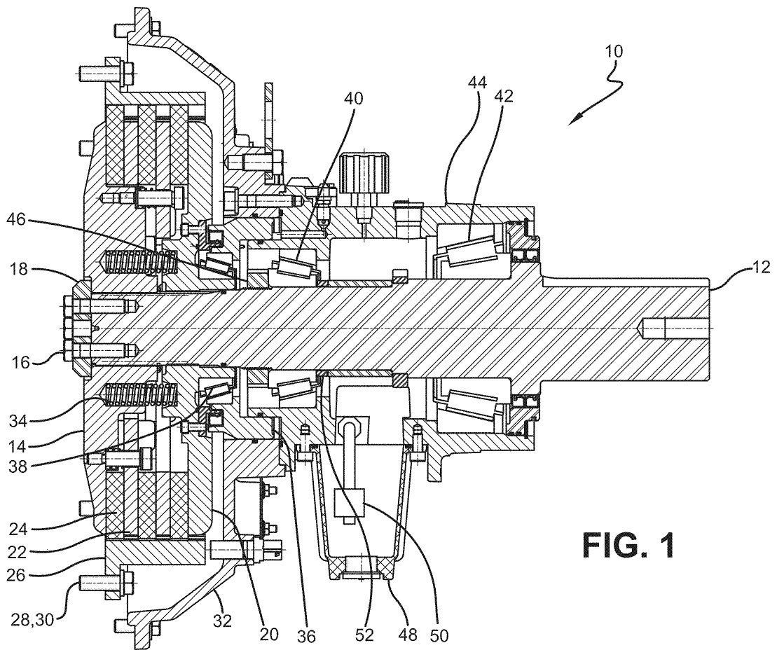

With reference now to FIG. 1, an appreciation can be obtained regarding the structure and operation of one embodiment of the clutch of the invention designated generally by the numeral 10. As shown, a shaft 12 is adapted to be driven by a power source (not shown) at a first end thereof. As will become apparent below, the shaft 12 is splined at its first end to receive and engage an endplate and pressure plate, of the clutch, with separator discs connected thereto by shoulder bolts or the like. Friction discs are splined to a ring gear driven by a power source such as a motor or engine. An adapter, such as a pulley or the like, may be keyed or otherwise connected to a second end of the shaft 12 for the output driving force.

At the first end of the shaft 12 is an endplate 14, which is secured by cap screws to a clamp plate 18 in a recessed central area of the endplate 14. A pressure plate 20 is received by the shaft 12 and is adapted to be hydraulically driven. Sandwiched between the endplate 14 and pressure plate 20 is a disc stack comprising alternatingly interleaved separator discs 22 and friction discs 24 as is customary in multi-disc clutches and the like. Suffice it to say that the separator and friction discs 22, 24 are axially slidable into and out of engagement as by application of hydraulic force to the pressure plate 20, driving the discs of the disc stack into engagement against the endplate 14.

A ring gear 26 is provided with cap screws 28 and lock washers 30 to connect the ring gear 26 to the power source, and with the inner circumference of the ring gear being in splined interconnection with the outer circumference of the friction discs 24 of the disc stack. Similarly, the separator discs 22, connected by spring-biased shoulder bolts to the grounded endplate 14, are axially movable upon the shoulder bolts as a result of the splined interconnection of the shaft 12 with the grounded endplate 14 and axially movable pressure plate 20. This allows for tight axial packaging with minimal built-in clearance and also facilitates ease of repair and replacement.

A bell housing 32 is adapted for bolted interconnection to the power source. The bell housing 32 encases and encloses the clutch assembly, protecting it from the environment, debris and the like.

A plurality of separator springs 34 are interposed between the endplate 14 and pressure plate 20 to ensure that the clutch is normally disengaged and is only engaged by the application of hydraulic pressure upon the piston 36 to drive the pressure plate 20. The springs 34, uniformly encircling the end of the shaft 12, ensure the separation between the pressure plate and endplate when the clutch is disengaged, providing for the separation of the friction and separator discs 24, 22.

In order to provide for the further compact nature of the compact, high-capacity, long-life clutch of the invention, a tapered roller bearing 38 is interposed between the pressure plate 20 and hydraulic piston 36 to serve as a thrust bearing for the pressure plate 20. This eliminates the need for traditional roller bearings and allows the bearing 38 to function as a thrust bearing, accommodating rotational movement while activating the clutch to accommodate increased load capacity.

A pair of tapered roller bearings 40, 42 is interposed between the shaft 12 and end cover 44. A bearing nut 46 is threaded onto the shaft 12 to preload the drive bearings 40, 42. Additionally, the inner race of the tapered roller bearing 40 is preloaded with a nested wave spring 52 to inhibit rotation of the inner race of that bearing with the shaft 12 and to further allow for ease of installation and rebuild. Those skilled in the art will appreciate that nested wave springs are typically flat wire wave springs having multiple turns coiled in parallel to produce forces proportional to the number of turns. In the present application, the nested wave spring accommodates significant loads in a physically compact package.

It will be appreciated that this bearing and shaft system, employing an indirect mount tapered roller bearing assembly in a preloaded condition, allows for higher radial loads, such as when belt drives are employed, and higher axial loads when the clutch is actuated and the tapered roller bearings 38, 40, 42 are forcefully engaged. This bearing and shaft system further provides for an accommodation of system misalignment from loads, deflections, and structural characteristics of the input and output devices. It further allows both a transverse drive, such as a belt drive, or a direct application, such as direct shaft engagement, all while using the same bearing arrangement. This is achievable through the use of a bearing nut to put the drive bearings into preload.

Another feature of the invention is the ability to preclude operation of the clutch if oil levels are not adequate—even under extreme angle operating conditions. To this end, the invention employs an oil monitor. The oil pan 48 receives the hydraulic oil of the system and is provided with an oil level sensor 50, such as a float switch or the like, that drops when there is insufficient oil in the pan. This drop actuates the float switch of the sensor 50, which triggers or activates a warning light or other appropriate signal for the operator or for automatic disengagement following expiration of a countdown timer. Such a feature accommodates the use of the compact, high-capacity, long-life clutch of the invention, which is routinely exposed to harsh operating conditions and environments that demand the assurance of adequate oil.

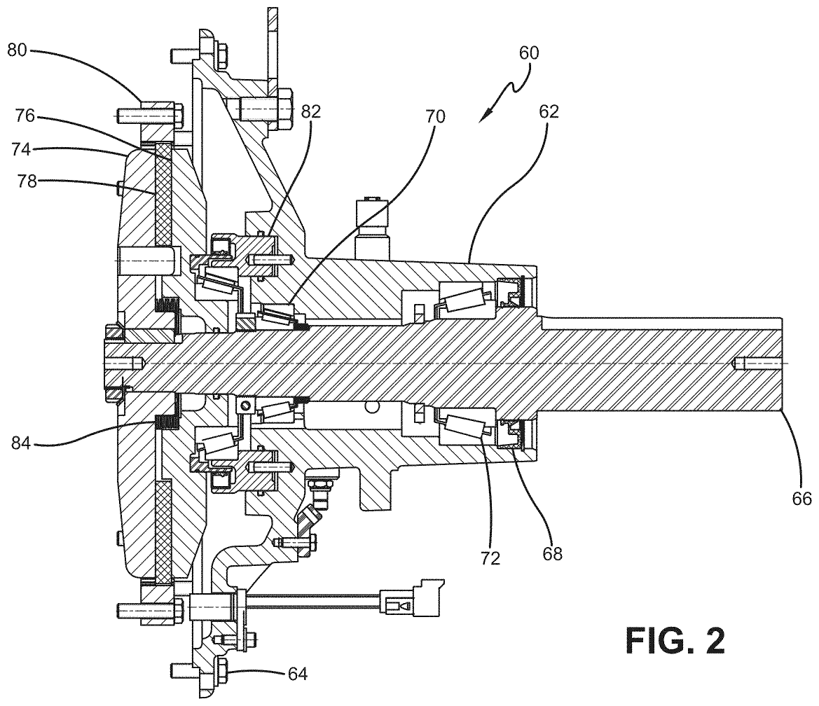

With reference now to FIG. 2, a second embodiment of the invention, particularly adapted to achieve significant cost savings for low-power, compact hydraulic clutch applications is designated generally by the numeral 60. It will be readily appreciated that the clutch 60 of FIG. 2 adopts a similar structural and operational layout as the clutch 10 of FIG. 1, but with significant cost savings, particularly achievable for low-power applications.

To begin, the bell housing 32 and end cover 44 of the clutch 10 of FIG. 1 is replaced with a consolidated main housing 62, uniquely adapted for interconnection with a power source such as a motor or engine by cap screws 64. The main housing 62 is integrated as a single, one-piece, complete casting with no auxiliary housings. Moreover, the necessary hydraulic chambers for engagement and disengagement of the clutch are built into the singular housing 62.

The shaft 66, received by the housing 62, is in operational sealed engagement with the housing 62 by means of a shaft seal 68 uniquely configured to form a custom seal having a combination single-lip seal and excluder built in. The single lip extends inwardly within the housing 62 and obviates the need for a seal cover and O-rings as common in the prior art.

As with the embodiment of FIG. 1, the shaft 66 is supported by tapered roller bearings 70, 72. At a first end of the shaft 66, there is a clutch mechanism comprising an endplate 74 and a pressure plate 76, sandwiching a friction plate 78, having a drive ring 80 about the outer circumference thereof to be driven by an appropriate power source such as an engine or motor. A piston 82, activated by hydraulic pressure, engages the pressure plate 78 to forcefully engage the friction plate 78 between the pressure plate 76 and the endplate 74, to achieve power-driven rotation of the shaft 66.

The activation of the clutch operates against a crest-to-crest wave spring 84, biasing a separation between the pressure plate 76 and endplate 74, which is overcome by activation of the piston 82.

According to a preferred embodiment of the invention, the crest-to-crest wave spring serves to reduce the requirement of machined features and the machining time necessary for the disc pack components. The crest-to-crest wave springs are configured such that they are stacked in series, with the spring rate being decreased proportionally to the number of turns. Their design eliminates the need to keep wave crests aligned and eliminates the need to use a key locating device or shims between individual springs. Because the spring is integrally formed, the wave peaks hold their configuration. Most importantly for the application here, such springs are axially compact, requiring on the order of half the space of helical compression springs, while accommodating the same force in load specifications.

The compact hydraulic clutch for low-power applications 60, as shown in FIG. 2 and described above, provides significant cost savings by integrating the bell housing and end cover into a single complete casting, providing the hydraulic chambers within the housing itself, by employing a custom seal having a combination single-lip seal and excluder built in, and by employing a crest-to-crest wave spring in the disc pack to reduce machined features and the time and expense spent on disc pack components. All of this is done without sacrificing reliability, durability, and responsiveness.

Thus it can be seen that the various aspects of the invention have been achieved by the structure presented and described above. While in accordance with the patent statutes only the best mode and preferred embodiment of the invention has been presented and described in detail, the invention is not limited thereto or thereby. Accordingly, for an appreciation of the scope and breadth of the invention reference should be made to the following claims.

What is claimed is:

1. A compact, long-life clutch, comprising:
a shaft;
an endplate and a pressure plate operatively mounted to an end of said shaft;
at least one friction disc interposed between said endplate and pressure plate;
a drive ring adapted for driven engagement by a power source and receiving said at least one friction plate;
a bell housing adapted for mounting to a housing of said power source and enclosing said endplate, pressure plate, and friction disc; and
wherein said shaft is rotatably mounted within an end cover by first and second tapered roller bearings.

2. The compact, long-life clutch according to claim 1, wherein said at least one friction disc is mounted to said drive ring.

3. The compact, long-life clutch according to claim 2, wherein said drive ring is a ring gear having said at least one friction disc axially movable thereon.

4. The compact, long-life clutch according to claim 3, further comprising a spring interposed between said pressure plate and endplate.

5. The compact, long-life clutch according to claim 4, wherein said spring comprises a crest-to-crest wave spring.

6. The compact, long-life clutch according to claim 3, further comprising a hydraulic piston engaging said pressure plate and a thrust bearing for said pressure plate interposed between said pressure plate and hydraulic piston.

7. The compact, long-life clutch according to claim 6, wherein said thrust bearing comprises a third tapered roller bearing.

8. The compact, long-life clutch according to claim 7, further comprising a nut threaded onto said shaft in preloading engagement with said first and second tapered roller bearings.

9. The compact, long-life clutch according to claim 8, wherein an inner race of one of said first and second tapered roller bearings is preloaded with a wave spring, inhibiting rotation of said inner race upon said shaft.

10. The compact, long-life clutch according to claim 9, wherein said wave spring is a nested wave spring.

11. The compact, long-life clutch according to claim 3, further comprising an oil pan having an associated oil level sensor, emitting a signal when an oil level within said oil pan drops below a set level.

12. The compact, long-life clutch according to claim 6, wherein said bell housing and end cover are integrated in a single casting.

13. The compact, long-life clutch according to claim 12, wherein said single casting includes hydraulic chambers and passages for clutch operation.

14. The compact, long-life clutch according to claim 13, further comprising a shaft seal interposed between said shaft and said single casting, said shaft seal comprising a single lip seal with a built-in excluder.

15. A compact, long-life clutch, comprising:
a shaft rotatably mounted within an end cover by first and second tapered roller bearings;
an endplate and a pressure plate operatively mounted to an end of said shaft;
at least one friction disc interposed between said endplate and pressure plate;
a drive ring adapted for driven engagement by a power source and receiving said at least one friction disc;
a bell housing adapted for mounting to a housing of said power source and enclosing said endplate, pressure plate and friction disc; and
a hydraulic piston engaging said pressure plate and a thrust bearing for said pressure plate interposed between said pressure plate and hydraulic piston.

16. The compact, long-life clutch as recited in claim 15, wherein said thrust bearing comprises a third tapered roller bearing.

17. The compact, long-life clutch as recited in claim 16, wherein said first tapered roller bearing is preloaded by a nut threaded upon said shaft.

18. The compact, long-life clutch as recited in claim 17, wherein said first tapered roller bearing is further preloaded by a wave spring.

19. The compact, long-life clutch as recited in claim 18, further comprising multiple friction discs interleaved with separator discs, axially slidingly engageable between said endplate and pressure plate.

20. The compact, long-life clutch as recited in claim 20, further comprising a wave spring in separating engagement between said endplate and pressure plate.
